(19) United States
(12) Patent Application Publication
(10) Pub. No.: US 2003/0033793 A1
(43) Pub. Date: Feb. 20, 2003

(54) Rake panel device and method of making and using the same

(76) Inventor: William Cody Fairbanks, Sandy, UT (US)

Correspondence Address: TRASK BRITT, P.O. BOX 2550, SALT LAKE CITY, UT, 84110, US

(21) Appl. No.: 09/932,594

(22) Filed: Aug. 17, 2001

(51) Int. Cl. A01D 7/00

(52) U.S. Cl. 56/400.1

(57) ABSTRACT

A method and apparatus for manually handling large quantities of debris and placing such debris into containers. The method and apparatus is directed to a rake panel utilized in combination with a rake. The rake panel includes a panel and an open sleeve configured to removably attach with a rake via an interference fit. In one embodiment, the open sleeve removably attaches to a rake shaft, and in another embodiment, the open sleeve removably attaches to a rake head. The rake panel therefore is easily attachable and removable to and from a rake and, therefore, easily accessible with the rake. The rake panel also simplifies handling debris by simply sandwiching large quantities of debris between the rake panel and a rake head, making for easier cleanup.

### BACKGROUND OF THE INVENTION

Field of the Invention: The present invention relates to a method and apparatus for handling and removing debris from a pile into a container. More particularly, the present invention relates to a compact, light weight rake panel in combination with a rake for assisting in the manual removal of large quantities of debris into a container.

State of the Art: Residential areas filled with deciduous trees experience the splendor of autumn every year as the leaves change color. However, there is a price to pay as autumn progresses and the leaves fall to the ground. Homeowners find themselves saddled with the task of removing the leaves from their lawn. The typical process of removing leaves involves raking or blowing the leaves into piles and then filling bags or cans with the leaves for disposal. The process of leaning down and bending over to pick up leaves from a pile by hand can be difficult work that leads to muscle fatigue and pain.

Numerous tools have been developed which attempt to ease the process of leaf removal. For example, U.S. Pat. No. 5,564,267 discloses a rake having a shaft and a shovel having a shaft, in which the two are pivotally connected midway up the shaft. Such rake and shovel combination is used together in a scissor like arrangement to pick up debris such as leaves. Additionally, U.S. Pat. Nos. 5,901,540, 5,564,266 and 4,378,671 disclose two rakes with their respective shafts having a pivotal connection. Although useful for picking up debris, the pivotal connections in each of the above-noted patents include many intricate parts making the pivotal connection relatively high in cost. Such intricate pivotal connections may also easily break and misfunction. Additionally, two separate tools, i.e., rake and shovel, pivotally connected may be awkward to use, making it difficult to be efficient in the desired easy removal of leaves or other types of debris.

U.S. Pat. No. 5,644,796 discloses a work glove rake including a glove with rake tines at the end of each finger on the glove. Such glove may be helpful in removing leaves from hard to reach areas, but the rate by which one can remove leaves or debris is not any better than picking the leaves up without a tool. U.S. Pat. No. 5,706,640 discloses a landscaping debris collecting device, which includes a right and left plate member. Each plate member includes a rake end and a handle end for collecting and moving debris by sandwiching the debris between the plate members. However, such plate members require one to bend and lean to rake the piles prior to disposing the debris. The plate members also are not compactly and removably attachable to either a rake nor each other, resulting in two additional loose tools in one's tool collection array. In addition, the handle on each of the plate members lack wrist and arm support and may become tiresome when removing large quantities of debris over time.

Therefore, an apparatus and method for making the same is needed that provides advantages of easily collecting debris into piles and removing large quantities of such debris at a time into containers while also providing wrist and arm support, and including a compact simplified design without the complicated, expensive and misfunctional pivotal connections as part of the apparatus.

### BRIEF SUMMARY OF THE INVENTION

The present invention relates to an apparatus and method for manually handling large quantities of debris and disposing such debris into containers. The present invention is directed to a rake panel having a rake attachment portion which is attachable to a rake by an interference connection.

In one embodiment, the rake panel includes a rake attachment portion and a panel portion having a front surface and a back surface. The panel portion may be shaped to substantially follow the general periphery of a rake head. An aspect of the first embodiment provides the rake attachment portion to include an open sleeve having a C-shaped cross-section. Such open sleeve is configured to engage with the shaft of a rake and attach thereto with an interference connection. In another embodiment, the rake panel includes a rake attachment portion having an open sleeve with a U-shaped cross-section so that such open sleeve is configured to engage with a rake head of a rake and attach thereto with an interference connection.

One aspect of the present invention provides for the rake panel to include a handle and an arm support. The handle may be included in or on a back face of the rake panel. Such arm support provides a brace against one's arm when holding the handle as a load is placed on the front face of the rake panel while handling debris. In another aspect of the present invention, the handle and arm support of the rake panel may be included in the rake head of a rake. In another aspect of the present invention, the rake panel may include a handle in the form of a shaft extending therefrom utilized as a holding device when operating such rake panel. Thus, the arm support and handle provided on the rake panel and/or the rake head substantially simplifies handling debris and placing such debris into containers. Further, the rake panel of the present invention provides for a simplified and compact method and apparatus for attaching the rake panel to a rake.

### BRIEF DESCRIPTION OF THE SEVERAL VIEWS OF THE DRAWINGS

The method and apparatus of the present invention will be more fully understood from the detailed description of the invention taken in conjunction with the drawings, wherein:

FIG. 1 illustrates an exemplary rake used for raking debris such as grass and leaves, which rake may be used in combination with the present invention;

FIG. 2 illustrates a perspective view of a rake panel according to a first embodiment of the present invention;

FIG. 3 illustrates a cross-section of a portion of the rake panel along line 3 in FIG. 2, according to a first embodiment of the present invention;

FIG. 4 illustrates a perspective view of the rake panel of FIG. 2 attached to the shaft of an exemplary rake, according to a first embodiment of the present invention;

FIG. 5 illustrates a perspective view of a rake panel according to a second embodiment of the present invention;

FIG. 6 illustrates a cross-section of a portion of the rake panel along line 6 in FIG. 5, according to a second embodiment of the present invention;

FIG. 7 illustrates a perspective view of the rake panel of FIG. 5 attachable to the back side of a rake head of an exemplary rake, according to a second embodiment of the present invention;

FIG. 8 illustrates a perspective view of a handle and arm support according to an aspect of the present invention;

FIG. 9 illustrates a perspective view of an alternative handle according to an aspect of the present invention;

FIG. 10 illustrates a perspective view of the handle and arm support depicted in FIG. 8 embodied with a rake head of an exemplary rake, according to another aspect of the present invention;

FIG. 11 illustrates a method of using the handle and arm support embodied in a rake head of an exemplary rake, according to the present invention; and

FIGS. 12-14 illustrate simplified perspective views of a method of utilizing a rake panel and an exemplary rake in combination, according to the present invention.

### DETAILED DESCRIPTION OF THE INVENTION

Embodiments of the present invention will be hereinafter described with reference to the accompanying drawings. It should be understood that the illustrations are not meant to be actual views of any particular apparatus and/or method, but are merely idealized representations which are employed to more clearly and fully depict the present invention then would otherwise be possible. Additionally, elements common between figures retain the same numerical designation.

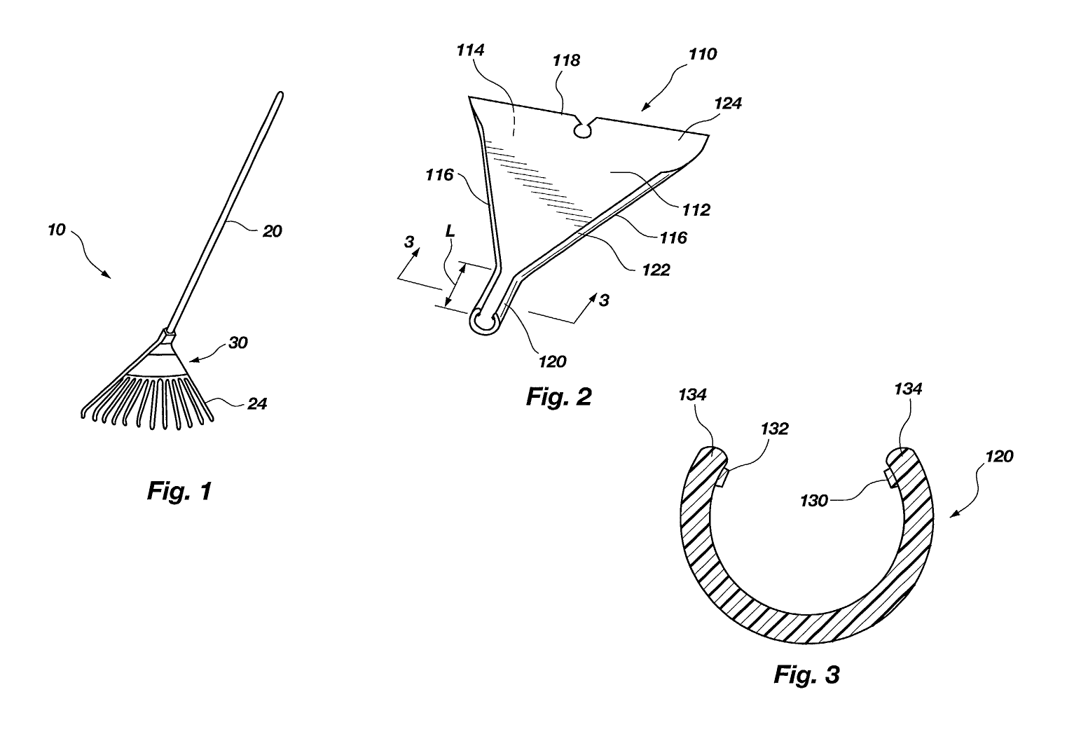

FIG. 1 depicts an exemplary rake 10 used for raking leaves and debris as contemplated to be used in combination with the present invention. In particular, rake 10 includes a shaft 20 and a rake head 30 having prongs 34 spanned therefrom, wherein one end of the shaft 20 is connected to the rake head 30. Rake 10 may be any type of rake used for raking leaves and debris.

FIG. 2 is a perspective view of a rake panel 100 according to a first embodiment of the present invention. Rake panel 100 includes a panel 110 having a front face 112 and a back face 114. Preferably, the panel 110 is sized and shaped, but is not limited to such size and shape, to correspond with a peripheral shape of a rake head and its prongs that the particular rake panel 100 is associated with. For example, panel 110 may be triangular in shape to correspond with the peripheral shape of the rake head 30 and the prongs 34 extending therefrom shown in FIG. 1.

As depicted in FIG. 2, panel 110 may include a triangular periphery with three main edges, including two side edges 116 and an end edge 118. The side edges 116 include a flange 122, which may extend along a majority of the length of the side edges 116, and extends outward from the front face 112 of the panel 110. The end edge 118 of the panel 110 includes a lip 124, which preferably extends outward from the front face 112 of the panel 110. Such flange 122 and lip 124 extending from side edges 116 and end edge 118, respectively, are shaped and configured for scooping and holding debris within the rake panel 100. To assist in scooping debris, it is contemplated that the lip 124 may include multiple prong like protrusions (not shown). Such protrusions may extend outward from the lip 124 or comprises the lip 124 itself. Additionally, the panel 110 may include an aperture 126 proximate a center portion of the lip 124 in the panel 110.

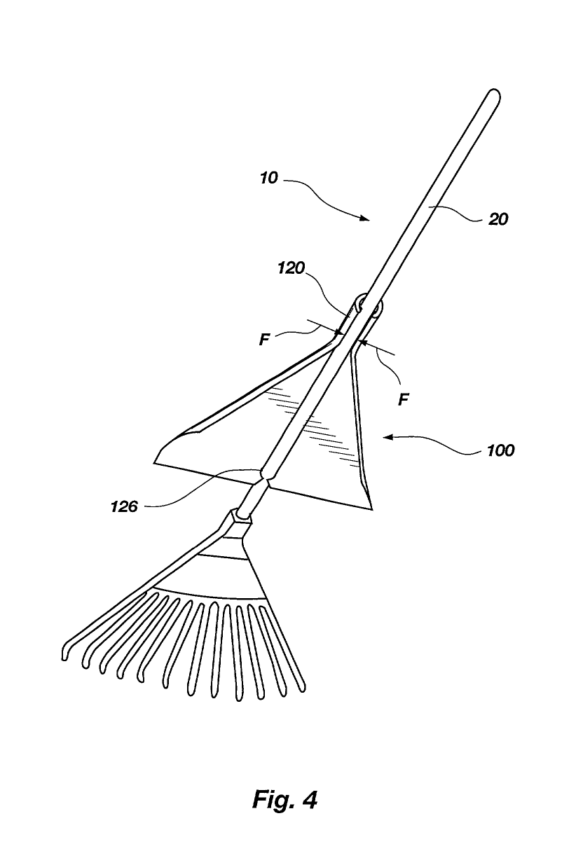

The side edges 116 of the rake panel 100 extend to an open sleeve 120 at the ends of the flange 122 on each side edge 116, where the side edges proximately come together and meet. Such open sleeve includes a c-shaped cross-section as shown in FIG. 3 taken from line 3 of FIG. 2. On an inside sleeve surface 130 of the open sleeve 120 there may be one or more protrusions 132. The one or more protrusions may extend longitudinally along the length L of the inside sleeve surface 130 and preferably proximate one or both end portions 134 of the C-shaped open sleeve 120. The one or more protrusions 132 may be a continuous protrusion along the length of the inside sleeve surface 130 and/or the protrusions 132 may comprises multiple non-continuous protrusions along the length of the inside sleeve surface 130. With this arrangement, the open sleeve 120 is configured to engage with and removably attach to a shaft via an interference fit or a friction fit.

The rake panel 100 is preferably formed from a polymer, such as a polyethylene amongst other known polymers, however, rake panel 100 may be formed from any suitable material as known to one of ordinary skill in the art. Such polymer formed rake panel 100 is preferably formed as a single member by an injection molding technique or other techniques as known in the art. However, the rake panel may also be formed from multiple parts, such as the panel 110 and the open sleeve 120, which may be fastened together by any suitable fastener.

FIG. 4 depicts a perspective view of rake panel 100 attached to the shaft 20 of rake 10. As shown, the c-shaped open sleeve 120 is configured to attach to shaft 20 with an interference fit, which may be removably attachable at any portion along shaft 20. Also, with open sleeve 120 attached to shaft 20, the shaft 20 may extend through the aperture 126 in the panel 110. The open sleeve 120 is designed with the necessary elasticity parameters, which may easily be determined by one skilled in the art, so as to provide the interference fit. Such elasticity parameters preferably allow the end portions 134 of the C-shaped open sleeve to expand when inserting the shaft between such end portions 134 so that such end portions are exerting a biasing force F on the shaft to facilitate the interference fit. Once the shaft 20 is fully inserted past the protrusions 132, the end portions 134 clamp around the shaft 20 with the biasing force F so that the inside sleeve surface 130 abuts with the surface of the shaft 20 resulting in the interference fit. As such, the open sleeve 120 provides the necessary friction so as to prevent rake panel 100 from sliding up and down shaft 20.

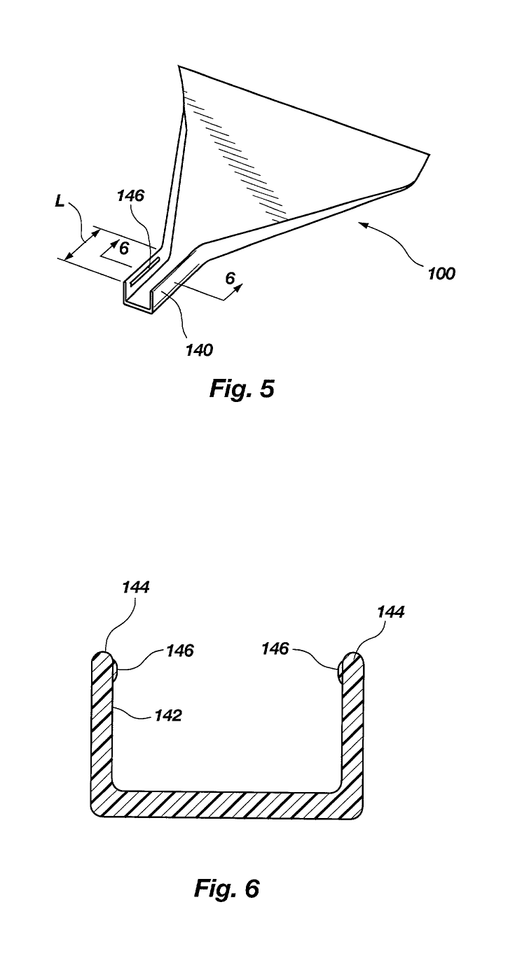

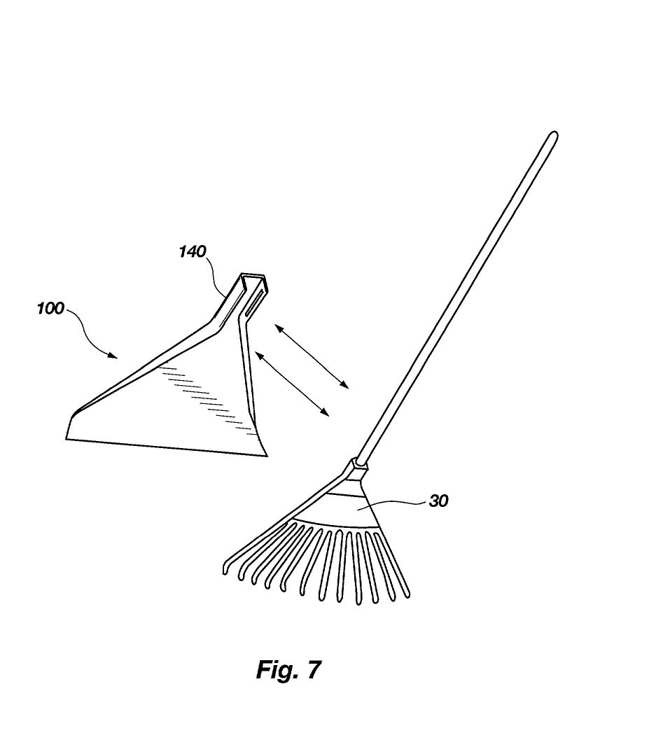

FIG. 5 is a perspective view depicting rake panel 100 in a second embodiment according to the present invention. The second embodiment is the same as the first embodiment in every respect except that the open sleeve 140 includes a u-shaped cross section and, additionally, there may be no aperture 126 defined in the panel 110, as shown in FIG. 6 taken along line 6 in FIG. 5. As depicted in FIG. 6, the U-shaped open sleeve 140 includes inside sleeve surface 142 with end portions 144 and one or more protrusions 146 formed proximate the end portions 144 on the inside sleeve surface 142. As in the previous embodiment, the one or more protrusions 146 may extend longitudinally along the length L of the inside sleeve surface 142 and preferably proximate one or both end portions 144 of the U-shaped open sleeve 140. The one or more protrusions 146 may be continuous protrusions along the length of the inside sleeve surface 142 and/or the one or more protrusions 146 may comprises multiple non-continuous protrusions along the length of the inside sleeve surface 142. With this arrangement, the open sleeve 140 is configured to engage with and removably attach to the back side of a rake head 30 via an interference fit or a friction fit, as depicted in FIG. 7. Such interference fit is employed in a similar manner as described in the previous embodiment.

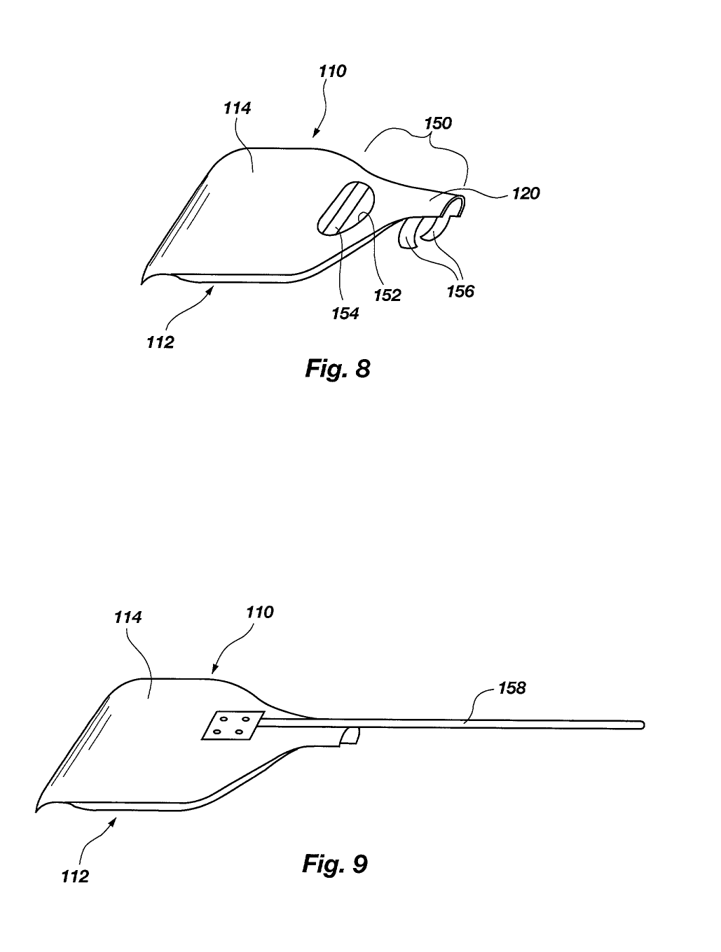

FIGS. 8 and 9 are perspective views of holding means 150 for the rake panel 100 according to another aspect of the present invention. As depicted in FIG. 8, rake panel 100 may include an opening 152 in the panel 110 adjacent the open sleeve 120, wherein the opening 152 includes a handle 154 in the form of a shaft extending across the opening 152. Alternatively, a handle 154 may be directly secured to the back face 114 of the panel 110 without the opening therein. In addition, an arm rest 156 may be provided to brace against ones arm when holding the handle 154 as loads are placed on the front face 112 of the panel 110 while handling debris. FIG. 9 depicts another holding means, by which rake panel 100 includes a panel shaft 158 extending from the back face 114 of panel 110 and/or from the open sleeve 120.

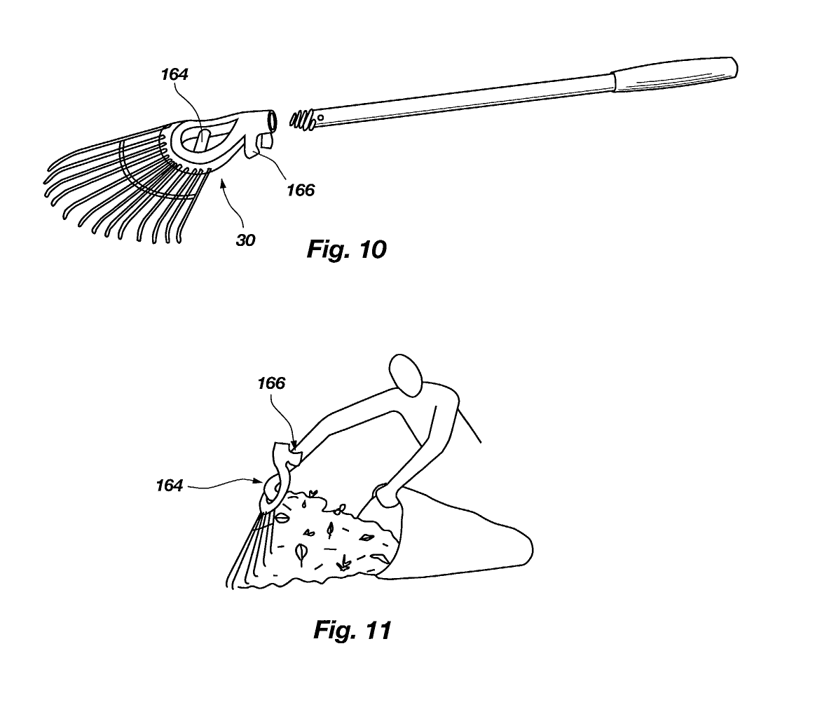

In another aspect of the present invention, it is contemplated that the handle 154 and arm support 156 included on rake panel 100 may be included on the rake head 30 of the rake 10 itself as handle 164 and arm support 166 (FIG. 10). Such handle 164 and arm support 166 allows one to easily hold a container with one hand and move debris into such container with the other hand by utilizing such rake head 30 with the handle 164 and arm support 166, as depicted in FIG. 11. Further, such handle 164 allows easy maneuverability for tight areas and corners, such as, but not limited to, under trees and shrubs and the like.

It is contemplated that the rake panel 100 depicted in FIGS. 8 and 9 may, or may not, include the open sleeve 120 for attaching the rake panel 110 to a rake 10, wherein the rake panel 100 may be attached by some alternate means, such as by a tab, string, cord, velcro, or any other means known in the art. Additionally, it is contemplated that the rake panel 100 may not include an attaching means as previously described. As such, the rake panel 100 of the present invention may be operable with a rake head, a second rake panel, or any panel-like object that is configured for assisting rake panel 100 in sandwiching debris therebetween, and further, rake panel may (or may not) be attachable to such panel-like object used for assisting the rake panel.

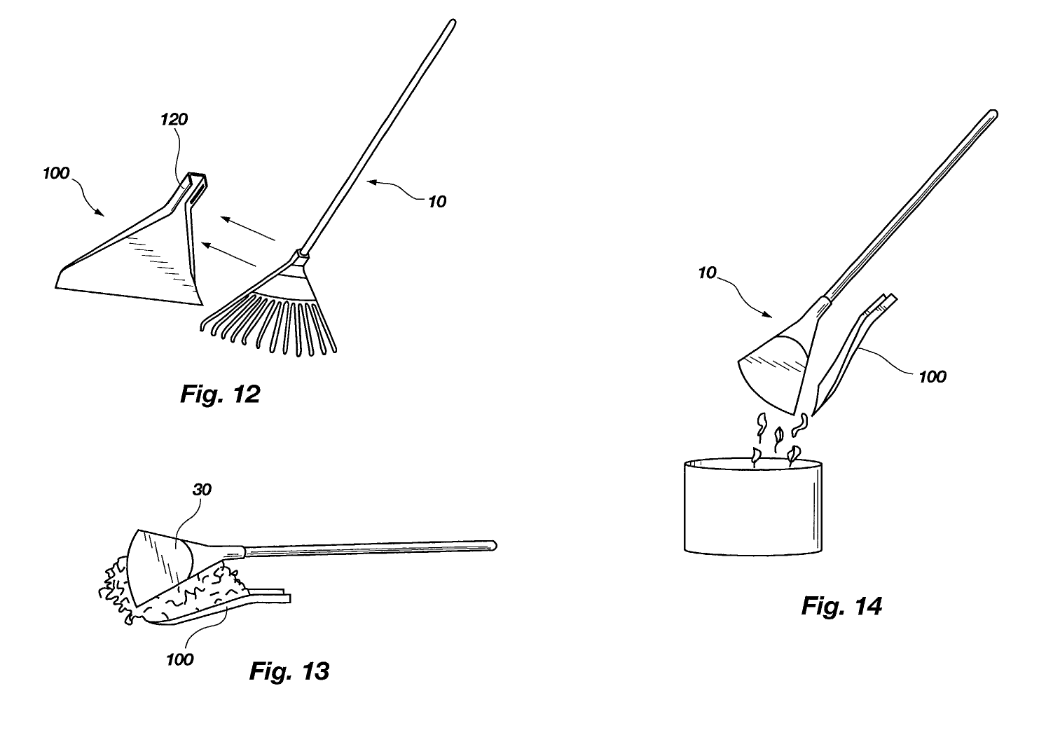

FIGS. 12 through 14 depict a method of using the rake panel 100 according to the present invention. FIG. 12 illustrates detaching the rake panel 100 from a rake 10 by simply pulling apart the interference fit effected by the open sleeve 120. FIG. 13 illustrates sandwiching debris between the rake panel 100 and the rake head 30, which is a relatively larger quantity of debris compared to the conventional method of sandwiching debris between ones hand and the rake head. FIG. 14 illustrates discarding the sandwiched debris into a container, such as a waste container, by simply separating the hand held rake panel 100 and rake 10.

Thus, the arm support and handle provided on the rake panel and/or the rake head substantially simplifies handling debris by allowing one to easily handle large quantities of debris at a time, and then placing such large quantities of debris into containers. Further, attachment portion of the rake panel includes advantages of being simplified, compact and durable.

While the present invention has been disclosed in terms of a certain preferred embodiments and alternatives thereof, those of ordinary skill in the art will recognize and appreciate that the invention is not so limited. Additions, deletions and modifications to the disclosed embodiments may be effected without departing from the scope of the invention as claimed herein. Similarly, features from one embodiment may be combined with those of another while remaining within the scope of the invention.

What is claimed is:

1. A combination rake and rake panel, the combination comprising:
a rake including a shaft and a rake head, said rake head having a first end and a second end thereof, said first end interconnected to a shaft end of said shaft, said rake head having rake prongs at said second end thereof configured to move debris; and
a rake panel having an attachable portion and a panel portion, said attachable portion extending from said panel portion, and said attachable portion removably attachable with said rake via an interference connection.

2. The combination of claim 1, wherein said rake panel is substantially shaped to correspond with a peripheral shape of said rake head.

3. The combination of claim 1, wherein said attachable portion of said rake panel is removably attachable with at least one of said shaft and said rake head.

4. The combination of claim 1, wherein said attachable portion comprises an open sleeve having a length along a longitudinal extent thereof, said open sleeve configured to bias against said at least one of said shaft and said rake head for said interference connection.

5. The combination of claim 4, wherein said open sleeve comprises at least one of a C-shaped cross-section and a U-shaped cross-section transverse to said longitudinal extent of said length.

6. The combination of claim 5, wherein said at least one of said C-shaped cross-section and said U-shaped cross-section comprises end portions continuously extending along said length.

7. The combination of claim 6, wherein said end portions comprise at least one protrusion on an inside surface of said at least one of said C-shaped cross-section and said U-shaped cross-section.

8. The combination of claim 6, wherein said end portions are configured to expand when removably attaching said open sleeve to said at least one of said shaft and said rake head to facilitate said interference connection.

9. The combination of claim 7, wherein said at least one protrusion is configured to engagedly hold said at least one of said shaft and said rake head to said open sleeve via said interference connection.

10. The combination of claim 1, wherein at least one of said rake panel and said rake head comprises a handle.

11. The combination of claim 10, wherein said at least one of said rake panel and said rake head comprises a support member configured to bias with one's arm when gripping said handle.

12. The combination of claim 1, wherein said panel portion comprises a front face having at least one flange extending outward from said front face, said at least one flange positioned proximately along a peripheral edge of said panel portion and configured to hold debris in said panel portion.

13. The combination of claim 1, wherein said rake panel includes a panel shaft extending from at least one of said panel portion and said attachable portion of said rake panel.

14. A leaf debris removing apparatus for use with a rake having a shaft and a rake head, said apparatus comprising:
a rake panel having an attachable portion and a panel portion, said attachable portion extending from said panel portion, and said attachable portion removably attachable with the rake via an interference connection.

15. The apparatus of claim 14, wherein said attachable portion of said rake panel is removably attachable with at least one of the shaft and the rake head.

16. The apparatus of claim 14, wherein said attachable portion comprises an open sleeve having a length along a longitudinal extent thereof, said open sleeve configured to bias against at least one of the shaft and the rake head for said interference connection.

17. The apparatus of claim 16, wherein said open sleeve comprises at least one of a C-shaped cross-section and a U-shaped cross-section transverse to said longitudinal extent of said length.

18. The apparatus of claim 17, wherein said at least one of said C-shaped cross-section and said U-shaped cross-section comprises end portions continuously extending along said length.

19. The apparatus of claim 18, wherein said end portions comprise at least one protrusion on an inside surface of said at least one of said C-shaped cross-section and said U-shaped cross-section.

20. The apparatus of claim 18, wherein said end portions are configured to expand when removably attaching said open sleeve to said at least one of the shaft and the rake head to facilitate said interference connection.

21. The apparatus of claim 19, wherein said at least one protrusion is configured to engagedly hold said at least one of the shaft and the rake head to said open sleeve via said interference connection.

22. The apparatus of claim 14, wherein at least one of said rake panel and the rake head comprises a handle.

23. The apparatus of claim 22, wherein said at least one of said rake panel and the rake head comprises a support member configured to bias with one's arm when gripping said handle.

24. The apparatus of claim 14, wherein said panel portion comprises a front face having at least one flange extending outward from said front face, said at least one flange positioned proximately along a peripheral edge of said panel portion and configured to hold debris in said panel portion.

25. The apparatus of claim 14, wherein said rake panel includes a panel shaft extending from at least one of said panel portion and said attachable portion of said rake panel.

26. A method of disposing of debris using a rake panel in combination with a rake, the method comprising:
providing a rake having a shaft and a rake head;
providing a rake panel having an attachable portion and a panel portion, said attachable portion extending from said panel portion, and said attachable portion removably attachable with said rake via an interference connection;
removing said rake panel from said rake;
piling the debris with said rake;
sandwiching the debris between said rake head and said rake panel; and
disposing the debris from between said rake head and said rake panel into a container.

27. A method of fabricating a rake panel for attaching to a rake having a shaft and a rake head, said method comprising:
forming a rake panel having an attachable portion and a panel portion; and
configuring said attachable portion to extend from said panel portion so that said attachable portion is removably attachable with the rake via an interference connection.

28. The method of claim 27, wherein said forming comprises molding said panel portion to be substantially shaped to correspond with a peripheral shape of the rake head.

29. The method of claim 27, wherein said configuring said attachable portion comprises forming an open sleeve having a length along a longitudinal extent thereof and forming said open sleeve to bias against said at least one of the shaft and the rake head for said interference connection.

30. The method of claim 29, wherein said forming said open sleeve comprises forming at least one of a C-shaped cross-section and a U-shaped cross-section transverse to said longitudinal extent of said length.

31. The method of claim 30, wherein said forming said at least one of said C-shaped cross-section and said U-shaped cross-section comprises forming end portions continuously extending along said length.

32. The method of claim 31, wherein said forming said end portions comprises forming at least one protrusion on an inside surface of said at least one of said C-shaped cross-section and said U-shaped cross-section.

33. The method of claim 31, wherein said forming said end portions comprises configuring said end portions to expand when removably attaching said open sleeve to said at least one of the shaft and the rake head to facilitate said interference connection.

34. The method of claim 32, wherein said forming said at least one protrusion comprises configuring said at least one protrusion to engagedly hold said at least one of the shaft and the rake head to said open sleeve via said interference connection.

35. The method of claim 27, further comprising forming a handle on said rake panel.

36. The method of claim 35, wherein said forming said handle comprises forming a support member configured to bias with one's arm when gripping said handle.

37. The method of claim 27, wherein said forming said panel portion comprises forming at least one flange extending outward from a front face and positioned proximately along a peripheral edge of said panel portion and configured to hold debris in said panel portion.

38. The method of claim 27, wherein said forming said rake panel comprises forming a panel shaft extending from at least one of said panel portion and said attachable portion of said rake panel.

39. A leaf debris removing apparatus for use with a rake having a shaft and a rake head, said apparatus comprising:
a rake panel having a handle portion and a panel portion, said handle portion extending from said panel portion, and said panel portion operable in conjunction with the rake head to sandwich debris between said panel portion and a surface of the rake head.

40. The apparatus of claim 39, wherein said handle portion includes a support member configured to bias with one's arm when gripping said handle portion.

41. The apparatus of claim 39, wherein said panel portion comprises a front face having at least one flange extending outward from said front face, said at least one flange positioned proximately along a peripheral edge of said panel portion and configured to hold debris in said panel portion.

42. The apparatus of claim 39, wherein said handle portion comprises a panel shaft extending outward from said panel portion.

43. The apparatus of claim 39, wherein said handle portion comprises an opening therein and a panel shaft, said panel shaft extending across said opening and connected to opposing sides of said opening.
